(19) United States
(12) Patent Application Publication
(10) Pub. No.: US 2020/0091479 A1
(43) Pub. Date: Mar. 19, 2020

(54) BATTERY MODULE WITH BOTTOM PLATE THAT FUNCTIONS AS A HEAT SPREADER

(71) Applicant: Tiveni MergeCo Inc., San Mateo, CA (US)

(72) Inventors: Heiner FEES, Bietigheim-Bissingen (DE); Andreas TRACK, Sachsenheim (DE); Ralf MAISCH, Abstatt (DE); Alexander EICHHORN, Eppingen (DE); Jörg DAMASKE, Freiberg (DE); Valentin BROKOP, Walheim (DE); Hans-Joachim PFLÜGER, Wüstenrot (DE); Claus Gerald PFLÜGER, Markgröningen (DE)

(21) Appl. No.: 16/569,476

(22) Filed: Sep. 12, 2019

Related U.S. Application Data
(60) Provisional application No. 62/730,739, filed on Sep. 13, 2018.

(51) Int. Cl. H01M 2/10; H01M 10/653; H01M 10/0525

(52) U.S. Cl. CPC H01M 2/1077; H01M 2220/20; H01M 10/0525; H01M 10/653

(57) ABSTRACT

An embodiment is directed to a battery module comprising an external frame that comprises a bottom plate configured to mechanically reinforce the battery module, and a plurality of battery cells enclosed by the external frame, wherein each of the plurality of battery cells is thermally coupled to the bottom plate to facilitate heat being spread between the plurality of battery cells via the bottom plate.

### CROSS-REFERENCE TO RELATED APPLICATIONS

The present Application for Patent claims the benefit of U.S. Provisional Application No. 62/730,739 with attorney docket no. TIV-180007P1, entitled “BATTERY MODULE WITH BOTTOM PLATE THAT FUNCTIONS AS A HEAT SPREADER”, filed Sep. 13, 2018, which is assigned to the assignee hereof and hereby expressly incorporated by reference herein in its entirety.

### BACKGROUND

### 1. Field of the Disclosure

Embodiments relate to a battery module with a bottom plate that functions as a heat spreader.

### 2. Description of the Related Art

Energy storage systems may rely upon battery cells for storage of electrical power. During operation (e.g., charge-discharge cycles), battery cells generate heat which can contribute to thermal aging of the battery cells. A need exists to reduce the impact of thermal aging to battery cells so as to extend their cycle life.

### SUMMARY

An embodiment is directed to a battery module comprising an external frame that comprises a bottom plate configured to mechanically reinforce the battery module, and a plurality of battery cells enclosed by the external frame, wherein each of the plurality of battery cells is thermally coupled to the bottom plate to facilitate heat being spread between the plurality of battery cells via the bottom plate.

### BRIEF DESCRIPTION OF THE DRAWINGS

A more complete appreciation of embodiments of the disclosure will be readily obtained as the same becomes better understood by reference to the following detailed description when considered in connection with the accompanying drawings, which are presented solely for illustration and not limitation of the disclosure, and in which:

FIG. 1 illustrates an example metal-ion (e.g., Li-ion) battery in which the components, materials, methods, and other techniques described herein, or combinations thereof, may be applied according to various embodiments.

FIGS. 2A-2C illustrate different perspectives of components of a battery module.

FIGS. 3A-3B illustrate different perspectives of an additional component of the battery module of FIGS. 2A-2C.

FIG. 4 illustrates a simplified side-perspective of one particular conventional battery module design.

FIG. 5A illustrates a battery module arrangement in accordance with an embodiment of the disclosure.

FIG. 5B illustrates a simplified side-perspective of a battery module design 500B in accordance with an embodiment of the disclosure.

FIGS. 6A-6C illustrate an example assembly procedure for the battery module arrangement.

### DETAILED DESCRIPTION

Embodiments of the disclosure are provided in the following description and related drawings. Alternate embodiments may be devised without departing from the scope of the disclosure. Additionally, well-known elements of the disclosure will not be described in detail or will be omitted so as not to obscure the relevant details of the disclosure.

Energy storage systems may rely upon batteries for storage of electrical power. For example, in certain conventional electric vehicle (EV) designs (e.g., fully electric vehicles, hybrid electric vehicles, etc.), a battery housing mounted into an electric vehicle houses a plurality of battery cells (e.g., which may be individually mounted into the battery housing, or alternatively may be grouped within respective battery modules that each contain a set of battery cells, with the respective battery modules being mounted into the battery housing). The battery modules in the battery housing are connected to a battery junction box (BJB) via busbars, which distribute electric power to an electric motor that drives the electric vehicle, as well as various other electrical components of the electric vehicle (e.g., a radio, a control console, a vehicle Heating, Ventilation and Air Conditioning (HVAC) system, internal lights, external lights such as head lights and brake lights, etc.).

Embodiments of the disclosure relate to various configurations of battery modules that may be deployed as part of an energy storage system. In an example, while not illustrated expressly, multiple battery modules in accordance with any of the embodiments described herein may be deployed with respect to an energy storage system (e.g., chained in series to provide higher voltage to the energy storage system, connected in parallel to provide higher current to the energy storage system, or a combination thereof).

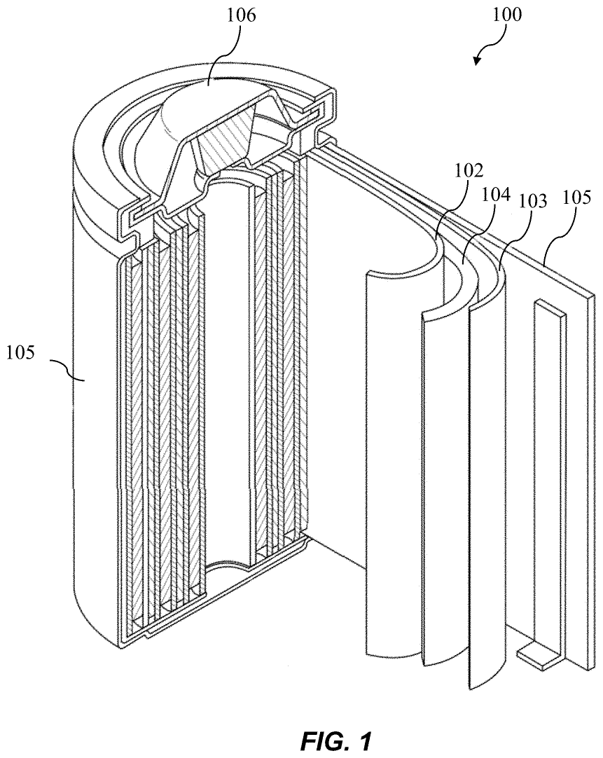

FIG. 1 illustrates an example metal-ion (e.g., Li-ion) battery in which the components, materials, methods, and other techniques described herein, or combinations thereof, may be applied according to various embodiments. A cylindrical battery is shown here for illustration purposes, but other types of arrangements, including prismatic or pouch (laminate-type) batteries, may also be used as desired. The example battery 100 includes a negative anode 102, a positive cathode 103, a separator 104 interposed between the anode 102 and the cathode 103, an electrolyte (shown implicitly) impregnating the separator 104, a battery case 105, and a sealing member 106 sealing the battery case 105.

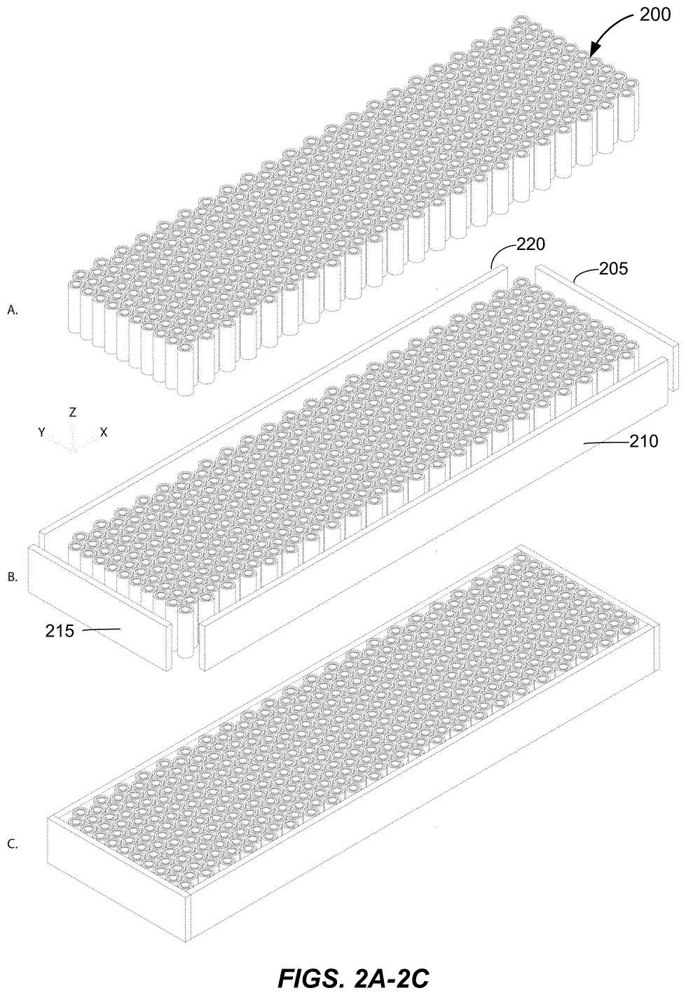

FIGS. 2A-2C illustrate different perspectives of components of a battery module. At FIG. 2A, a plurality of battery cells 205 are depicted, each of which may correspond to the battery 100 of FIG. 1 in an example. At FIG. 2B, “side” exterior framing parts 205, 210, 215 and 220 (e.g., side plates) of the battery module are depicted. At FIG. 2C, the side exterior framing parts 205, 210, 215 and 220 are shown in an installed state (e.g., via glue, form fit, force fit, screws, etc.) whereby the side exterior framing parts 205, 210, 215 and 220 enclose the battery cells 200.

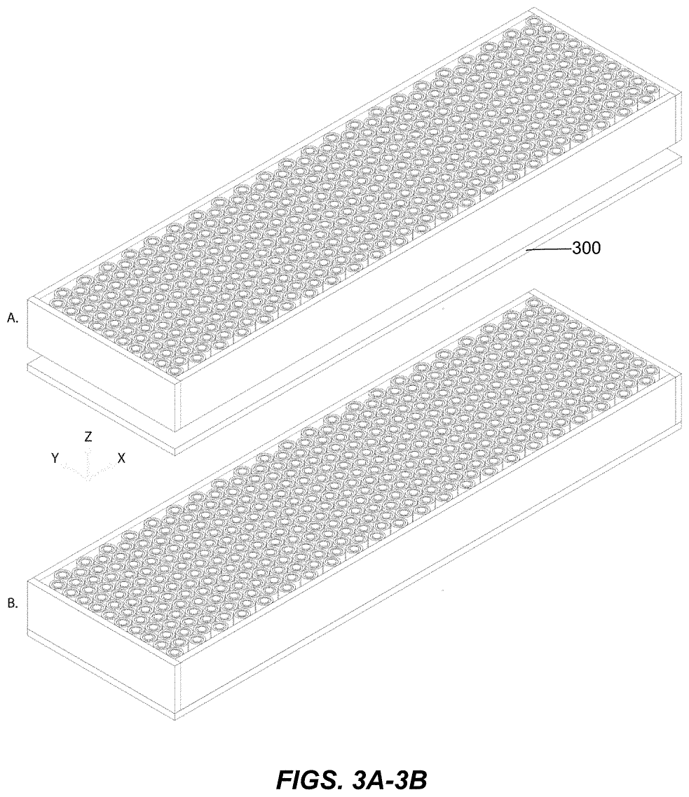

FIGS. 3A-3B illustrate different perspectives of an additional component of the battery module of FIGS. 2A-2C. At FIG. 3A, a “bottom” exterior framing part 300 (e.g., a bottom plate) is depicted. At FIG. 3B, the bottom exterior framing part 300 is shown in an installed state (e.g., via glue, form fit, force fit, screws, etc.) whereby the bottom exterior framing part 300 encloses the battery cells 200.

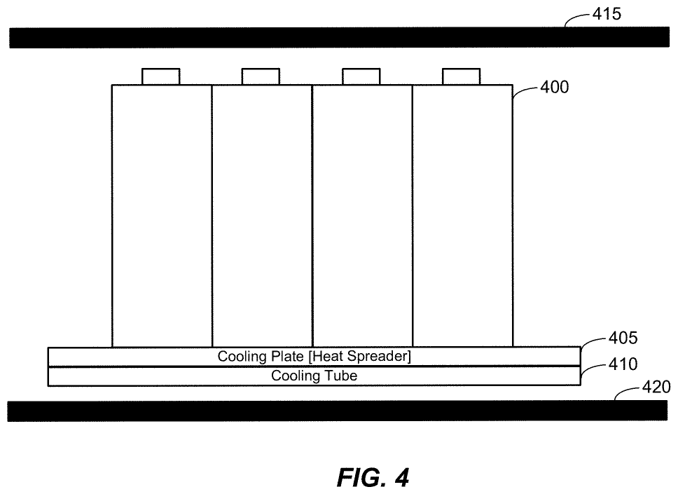

In certain conventional battery module designs, cooling of battery modules is implemented at the cell bottom. FIG. 4 illustrates a simplified side-perspective of one particular conventional battery module design. In FIG. 4, one or more groups of battery cells 400 are arranged on top of a cooling plate (or heat spreader) 405. A cooling tube 410 is further arranged underneath the cooling plate to transport heat away from the cell bottoms, whereby the cooling tube is configured to pump a liquid coolant provided from an external cooling system (not shown). The cooling tube 410 also provides a heat spreading function between the battery cells 400. All of the components 400, 405, 410 are structurally housed inside of a battery module frame that includes a top exterior framing part 415 and a bottom exterior framing part 420. The battery cells 400 are thermally coupled to the cooling plate 405 and cooling tube 410 to facilitate the cooling function. Other components such as contact plates for electrically interconnecting the battery cells 400, side exterior framing plates, etc., are not expressly shown in FIG. 4 for the sake of simplicity, but may be present.

However, the battery cells 400 are not thermally coupled to the bottom exterior framing part 420. Accordingly, the cooling plate 405 provides cooling and heat spreading functions without substantively contributing to a mechanical strength (e.g., z-fixation of battery cells inside the battery module) of the battery module housing or frame, whereas the bottom exterior framing part 420 provides mechanical strength (e.g., z-fixation of battery cells inside the battery module) to the battery module housing without substantively contributing to cooling and/or heat spreading functions with respect to the battery cells 400. Embodiments of the disclosure are thereby directed to an external framing part of a battery module that also functions as a heat spreader and/or cooling plate.

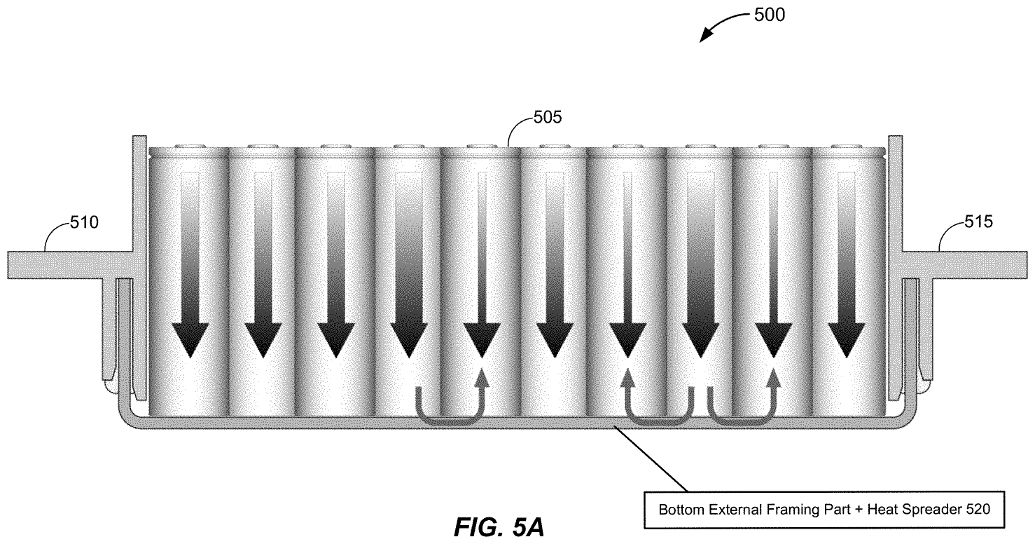

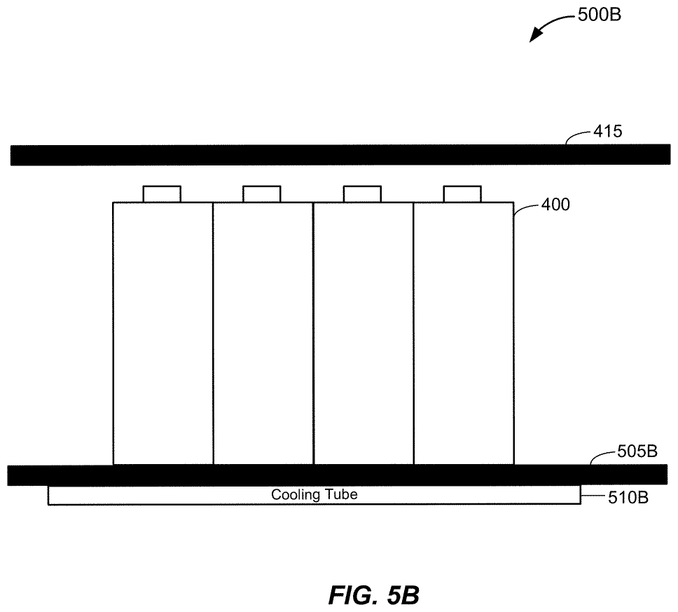

FIG. 5A illustrates a battery module arrangement 500 in accordance with an embodiment of the disclosure. Various components of the battery module (e.g., a top plate, etc.) are omitted from FIG. 5A, but may be present.

In FIG. 5A, one or more groups of battery cells 505 are enclosed by side external framing parts (or side plates) 510 and 515 as well as bottom external framing part (or bottom plate) 520. However, in the embodiment of FIG. 5A, the bottom plate 520 is further configured as a heat spreader that spreads heat between the various battery cells 505 of the battery module arrangement 500, as shown in FIG. 5A via arrows. For example, the bottoms of the battery cells 505 may be thermally coupled with the bottom plate 520 (e.g., via glue, thermally conductive and electrically insulative paste, etc.). In some designs, the thermally conductive and electrically insulative paste comprises stiff insulative objects (e.g., glass spheres or beads) configured to resist compression from a weight of the battery cells 505 so as to define a separation distance between the bottoms of the battery cells 505 and the bottom plate 520. This separation distance may function to electrically decouple (or isolate) the battery cells 505 from the bottom plate 520, while still permitting heat to flow from the battery cells 505 to the bottom plate 520 for heat spreading and/or cooling.

In some designs, the thermal coupling between the bottoms of the battery cells 505 with the bottom plate 520 may be accomplished in part by moving cooling tube outside of the battery module altogether, in contrast to the battery module arrangement 415 of FIG. 4, as shown in FIG. 5B.

FIG. 5B illustrates a simplified side-perspective of a battery module design 500B in accordance with an embodiment of the disclosure. The battery module design 500B is one example implementation of the battery module arrangement 500 described above with respect to FIG. 5A. In particular, the battery module design 500B is a modified version of the battery module design described above with respect to FIG. 4. In FIG. 5B, the battery cells 400 are thermally coupled to an external framing part 505B which functions as a heat spreader. In this particular example, the external framing part 505B further functions as a cooling plate via a thermal coupling with a cooling tube 510B (which may be a direct or indirect thermal coupling), which is configured to pump a liquid coolant provided from an external cooling system (not shown). Accordingly, while the cooling plate 405 is an internal component of the battery module in FIG. 4, the cooling plate can instead be made part of an external framing part as shown with respect to FIG. 5B.

Turning back to FIG. 5A, arrow thickness is correlated with heat flow, such that heat from hotter battery cells 505 is radiated towards cooler battery cells 505 via the heat spreading function of the bottom plate 520, so as to equalize the cell temperatures across the battery module. While not shown in FIG. 5A (although shown in FIG. 5B), the bottom plate 520 may also function as a cooling plate if coupled to an external cooling mechanism (e.g., a cooling tube arranged underneath the battery module arrangement 500).

Referring to FIG. 5A, in an example, the bottom plate 520 may be secured to the battery module (e.g., to side plates of the battery module) via glue, form fit, force fit, screws, etc. In a further example, the bottom plate 520 may be configured as a sheet metal part (e.g., made from an aluminum material), or alternatively may be made from steel or plastic (e.g., a thermally conductive plastic). In some designs, if the bottom plate 520 comprises a thermally conductive and electrically insulative material (e.g., a thermally conductive plastic), the bottom plate 520 need not be electrically isolated from the battery cells 505 via a separate mechanism. For example, in some designs, the above-noted thermally conductive and electrically insulative paste may be used for implementations where the bottom plate 520 is electrically conductive (e.g., made from steel, aluminum, etc.), while the thermally conductive and electrically insulative paste can be omitted for implementations where the bottom plate 520 is electrically insulative (e.g., made from a thermally conductive and electrically insulative plastic). However, in other designs, the thermally conductive and electrically insulative paste can be used in conjunction with an electrically insulative bottom plate 520 to further increase the electrical isolation (or separation distance) between the battery cells 520 and various electrically conductive components (e.g., part of the battery module or outside of the battery module). It will further be appreciated that FIGS. 5A-5B demonstrates that a bottom plate may be used to provide a combined effect of both fixation of the cells in a z-direction as well as mechanical reinforcement of the battery module.

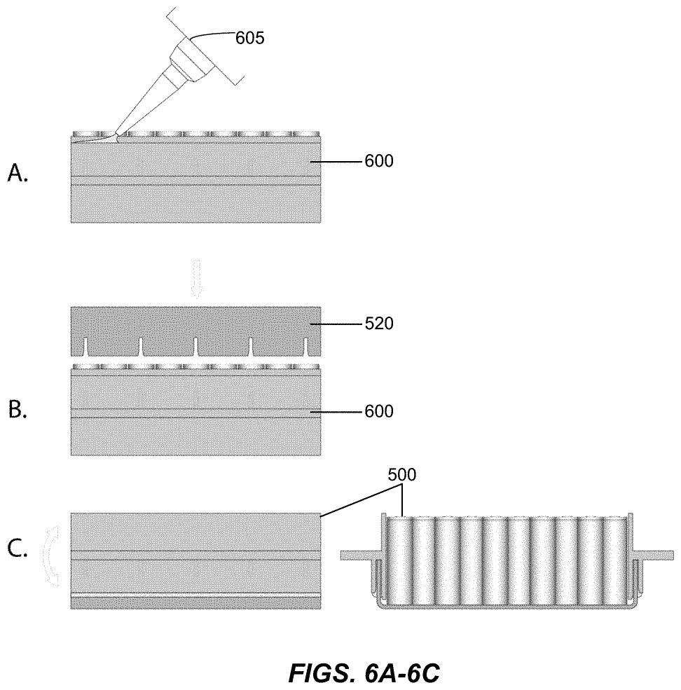

FIGS. 6A-6C illustrate an example assembly procedure for the battery module arrangement. At FIG. 6A, 600 denotes the battery cells 505 with an attached side plate (510 or 515). The battery module arrangement 600 is arranged upside down as shown in FIG. 6A, after which glue is deposited into a fixing slot for the bottom plate 520 via a glue dispenser 605. At FIG. 6B, the bottom plate 520 is secured to the battery module arrangement 600 via the applied glue. In an example, the glue applied at FIG. 6A may correspond to a thermally conductive and electrically insulative paste.

In an example, the side plates may include ribs in a slot and the bottom plate 520 may include cutouts to obtain a form fit after joining the parts. In one example, the bottom plate 520 may be configured with a “U” shape (e.g., as shown in FIG. 5A) to increase the stiffness of this part as well as the whole battery module, as well as additional z-fixation of the battery cells 505.

At FIG. 6C, the battery module arrangement from FIG. 6B is placed upright e.g., after the glue dries or hardens), at which point the battery module arrangement 500 of FIG. 5A has completed assembly. In an example, by spreading the heat across the battery cells 505, substantially homogeneous thermal aging of the battery cells 505 may be achieved, which improves reliability of the battery module.

While the embodiments described above relate primarily to land-based electric vehicles (e.g., cars, trucks, etc.), it will be appreciated that other embodiments can deploy the various battery-related embodiments with respect to any type of electric vehicle (e.g., boats, submarines, airplanes, helicopters, drones, spaceships, space shuttles, rockets, etc.).

Any numerical range described herein with respect to any embodiment of the present invention is intended not only to define the upper and lower bounds of the associated numerical range, but also as an implicit disclosure of each discrete value within that range in units or increments that are consistent with the level of precision by which the upper and lower bounds are characterized. For example, a numerical distance range from 7 nm to 20 nm (i.e., a level of precision in units or increments of ones) encompasses (in nm) a set of [7, 8, 9, 10, . . . , 19, 20], as if the intervening numbers 8 through 19 in units or increments of ones were expressly disclosed. In another example, a numerical percentage range from 30.92% to 47.44% (i.e., a level of precision in units or increments of hundredths) encompasses (in %) a set of [30.92, 30.93, 30.94, . . . , 47.43, 47.44], as if the intervening numbers between 30.92 and 47.44 in units or increments of hundredths were expressly disclosed. Hence, any of the intervening numbers encompassed by any disclosed numerical range are intended to be interpreted as if those intervening numbers had been disclosed expressly, and any such intervening number may thereby constitute its own upper and/or lower bound of a sub-range that falls inside of the broader range. Each sub-range (e.g., each range that includes at least one intervening number from the broader range as an upper and/or lower bound) is thereby intended to be interpreted as being implicitly disclosed by virtue of the express disclosure of the broader range.

The forgoing description is provided to enable any person skilled in the art to make or use embodiments of the invention. It will be appreciated, however, that the invention is not limited to the particular formulations, process steps, and materials disclosed herein, as various modifications to these embodiments will be readily apparent to those skilled in the art. That is, the generic principles defined herein may be applied to other embodiments without departing from the spirit or scope of the embodiments of the invention.

What is claimed is:

1. A battery module, comprising:
an external frame that comprises a bottom plate configured to mechanically reinforce the battery module; and
a plurality of battery cells enclosed by the external frame,
wherein each of the plurality of battery cells is thermally coupled to the bottom plate to facilitate heat being spread between the plurality of battery cells via the bottom plate.

2. The battery module of claim 1, wherein the bottom plate is thermally coupled to a cooling tube that is configured to pump a liquid coolant provided from an external cooling system.

3. The battery module of claim 1, wherein the bottom plate is secured to first and second side plates of the external frame.

4. The battery module of claim 3, wherein the bottom plate is form-fit into the first and second side plates via gluing.

5. The battery module of claim 3,
wherein the bottom plate is a U-shaped bottom plate,
wherein a first end of the U-shaped bottom plate is secured to the first side plate, and
wherein a second end of the U-shaped bottom plate is secured to the second side plate, and

6. The battery module of claim 1, further comprising:
thermally conductive material arranged between the plurality of battery cells and the bottom plate to facilitate the thermal coupling.

7. The battery module of claim 6, wherein the thermally conductive material is electrically insulative.

8. The battery module of claim 7, wherein the thermally conductive material comprises a thermally conductive and electrically insulative paste.

9. The battery module of claim 1, wherein each of the plurality of battery cells is thermally coupled to the bottom plate while being electrically isolated from the bottom plate.

10. The battery module of claim 1, wherein the bottom plate comprises steel or aluminum.

11. The battery module of claim 1, wherein the bottom plate comprises a thermally conductive plastic.
